(19) United States
(12) Patent Application Publication
(10) Pub. No.: US 2025/0296649 A1
(43) Pub. Date: Sep. 25, 2025

(54) WINDSHIELD DEVICE

(71) Applicants: NIFCO INC., Yokosuka-shi (JP); HONDA MOTOR CO., LTD., Tokyo (JP)

(72) Inventors: Hajime NAOI, Kanagawa (JP); Yoichi NISHIDA, Tokyo (JP)

(21) Appl. No.: 18/986,213

(22) Filed: Dec. 18, 2024

(30) Foreign Application Priority Data
Mar. 19, 2024 (JP) 2024-042996

(51) Int. Cl. B62J 17/04

(52) U.S. Cl. CPC B62J 17/04

(57) ABSTRACT

A windshield device includes: a fixing member configured to be fixed to a vehicle body and having first and second guide holes that are laterally spaced from each other; a shaft extending laterally and movably inserted in the first guide hole and the second guide hole; a holding member supported on the shaft; and a screen supported by the holding member. The first guide hole is provided with multiple first lock holes, and the second guide hole is provided with multiple second lock holes at positions laterally corresponding to the first lock holes. A first fitting part that can be selectively fitted in one of the first lock holes is fixed to the shaft, and a second fitting part that can be selectively fitted in one of the second lock holes is supported on the shaft to be movable in an axial direction of the shaft within a predetermined range.

### TECHNICAL FIELD

The present invention relates to a windshield device.

### BACKGROUND ART

JP6367263B2 discloses a windshield device for a saddle-ride type vehicle. The windshield device includes a fixing member fixed to the vehicle body, a screen, a holding member supporting the screen, and front and rear links connecting the holding member to the fixing member. The holding member, the fixing member, the front link, and the rear link jointly configure a four-section link. Due to pivoting of the front link and the rear link, the holding member and the screen can move relative to the fixing member.

The rear link includes left and right arm portions pivotably supported by the fixing member. The rear link is provided with a lock mechanism that restricts the pivoting of the rear link relative to the fixing member. The lock mechanism includes a shaft extending laterally to penetrate the left and right arm portions and the fixing member, left and right gears fixed to the shaft, a first engagement hole formed in the left arm portion, a second engagement hole formed in a left part of the fixing member, a third engagement hole formed in the right arm portion, a fourth engagement hole formed in a right part of the fixing member, an operation part provided at the left end of the shaft, and a spring urging the shaft leftward. In a lock state in which the shaft is moved to the left, the left gear is engaged with the first engagement hole and the second engagement hole, and the right gear is engaged with the third engagement hole and the fourth engagement hole, whereby the pivoting of the rear link relative to the fixing member is restricted. In a release state in which the shaft is moved to the right, the left gear is released from engagements with the first engagement hole and the second engagement hole, and the right gear is released from engagements with the third engagement hole and the fourth engagement hole, whereby the rear link is allowed to pivot relative to the fixing member.

However, in the configuration disclosed in JP6367263B2, if a manufacturing error or deformation occurs in any of the fixing member, the holding member, the rear link, the shaft, and the gears, a problem may occur in that in the lock state, the left gear cannot closely contact the first engagement hole and the second engagement hole or the right gear cannot closely contact the third engagement hole and the fourth engagement hole. As a result, the rear link, the holding member, and the screen may rattle, and the position of the screen cannot be kept stably.

### SUMMARY OF THE INVENTION

In view of the foregoing background, a primary object of the present invention is to provide a windshield device capable of stably keeping the position of the screen.

To achieve the above object, one aspect of the present invention provides
a windshield device (1), comprising: a fixing member (4) configured to be fixed to a vehicle body (3) and having a first guide hole (16) and a second guide hole (17) that are laterally spaced from each other; a shaft (5) extending laterally and movably inserted in the first guide hole and the second guide hole; a holding member (6) supported on the shaft; and a screen (7) supported by the holding member, wherein the first guide hole is provided with multiple first lock holes (31), the second guide hole is provided with multiple second lock holes (32) at positions laterally corresponding to the first lock holes, and a first fitting part (35) that can be selectively fitted in one of the first lock holes is fixed to the shaft, and a second fitting part (36) that can be selectively fitted in one of the second lock holes is supported on the shaft to be movable in an axial direction of the shaft within a predetermined range.

According to this aspect, since the second fitting part is supported to be movable in the axial direction of the shaft within the predetermined range, even if a manufacturing error or deformation occurs in the windshield device, the second fitting part can move relative to the shaft, so that the first fitting part can be fitted in the first lock hole and the second fitting part can be fitted in the second lock hole. Thus, a windshield device capable of stably keeping the position of the screen can be provided.

Preferably, in a state in which the first fitting part is fitted in one of the first lock holes and the second fitting part is fitted in one of the second lock holes corresponding to the one of the first lock holes, a fitting margin (L1) of the first fitting part with respect to the one of the first lock holes is set to be greater than a total of a fitting margin (L2) of the second fitting part with respect to the one of the second lock holes and a play length (L3) between the second fitting part and the shaft in a release direction.

According to this aspect, when the first fitting part is released from the first lock hole, the second fitting part which is movable relative to the shaft can be reliably released from the second lock hole.

According to the foregoing configuration, a windshield device

capable of stably keeping the position of the screen can be provided.

### BRIEF DESCRIPTION OF THE DRAWINGS

FIG. 1 is a side view showing a motorcycle which includes a windshield device according to one embodiment of the present invention;

FIG. 2 is a perspective view of the windshield device, with a screen being omitted;

FIG. 3 is a side view of the windshield device;

FIG. 4 is a sectional view of the windshield device (a sectional view taken along line IV-IV in FIG. 2);

FIG. 5 is an exploded perspective view of the windshield device;

FIG. 6 is a sectional view of the windshield device in a lock state;

FIG. 7 is a sectional view of the windshield device in a release state;

FIG. 8 is a perspective view of an operation part;

FIG. 9 is a perspective view of a right fitting part;

FIG. 10 is a sectional view showing a left guide hole and the operation part;

FIG. 11 is a perspective view of the windshield device, with a screen being omitted; and

FIG. 12 is a side view of the windshield device.

### DETAILED DESCRIPTION OF THE INVENTION

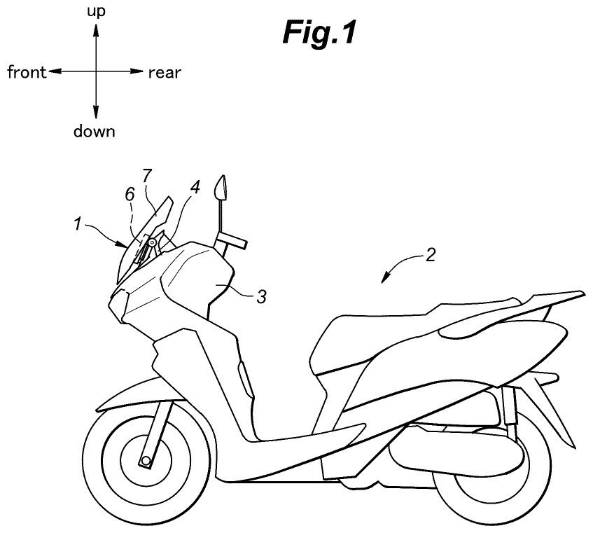

In the following, an embodiment in which a windshield device is applied to a motorcycle will be described. As shown in FIG. 1, a windshield device 1 is provided on a front portion of a vehicle body 3 of a motorcycle 2 which is a saddle-ride type vehicle, for example. The windshield device 1 is disposed in front of the rider and reduces the impact of wind on the rider.

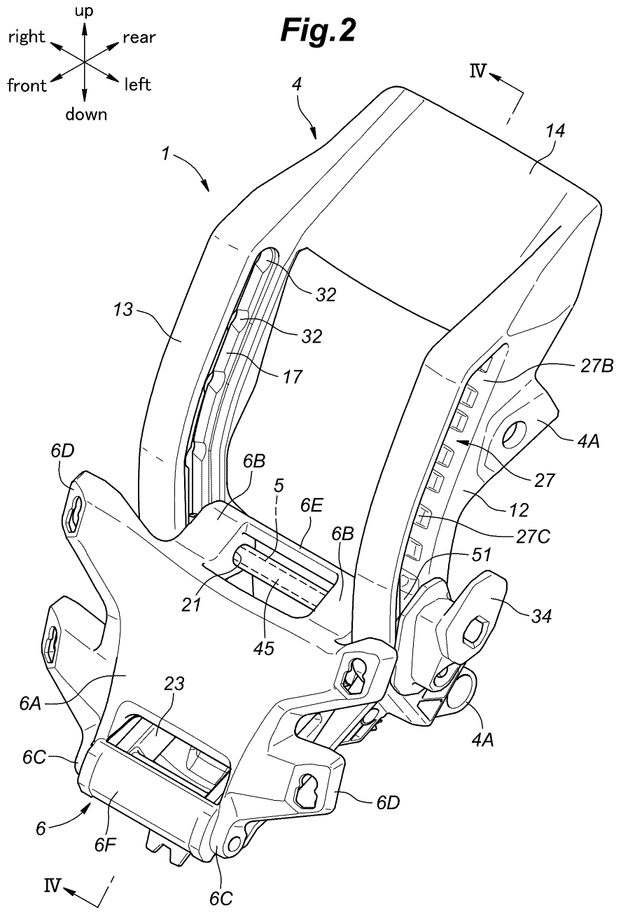

As shown in FIGS. 1 and 2, the windshield device 1 includes a bracket 4 serving as a fixing member configured to be fixed to the vehicle body 3, a shaft 5 supported by the bracket 4, a holder 6 serving as a holding member supported on the shaft 5, and a screen 7 supported by the holder 6.

As shown in FIGS. 2 to 5, the bracket 4 includes a bracket lower portion 11, a left guide part 12 and a right guide part 13 that extend upward and rearward from the rear end of the bracket lower portion 11, and a coupling part 14 extending laterally and joined to the rear ends of the left guide part 12 and the right guide part 13. The bracket lower portion 11 includes a lower wall portion 11A having an upward facing surface, left and right side wall portions 11B extending upward from left and right end portions of the lower wall portion 11A, and a rear wall portion 11C extending upward from the rear end of the lower wall portion 11A and joined to the left and right side wall portions 11B.

The bracket 4 has a left guide hole 16 (first guide hole) and a right guide hole 17 (second guide hole) that are laterally spaced from each other. The left guide hole 16 is formed in the left guide part 12, and the right guide hole 17 is formed in the right guide part 13. The left guide hole 16 penetrates the left guide part 12 laterally and extends in the up-down direction along the left guide part 12. The right guide hole 17 penetrates the right guide part 13 laterally and extends in the up-down direction along the right guide part 13. As seen in the lateral direction, the left guide hole 16 and the right guide hole 17 overlap each other. Preferably, the left guide hole 16 and the right guide hole 17 are curved so as to be convex forward and upward. Namely, the upper ends of the left guide hole 16 and the right guide hole 17 are positioned rearward of the lower ends of the left guide hole 16 and the right guide hole 17.

The shaft 5 extends laterally and is movably inserted in the left guide hole 16 and the right guide hole 17. The shaft 5 is movable in the extension direction of the left guide hole 16 and the right guide hole 17, namely, in the up-down direction. Also, the shaft 5 is movable in the axial direction of the shaft 5, namely, in the lateral direction.

The holder 6 includes a holder main body 6A that is in a plate shape and has a forward facing surface, left and right upper arms 6B protruding rearward from the upper end of the holder main body 6A, left and right lower arms 6C protruding downward from the lower end of the holder main body 6A, and multiple lateral arms 6D protruding to the left and right from left and right side edges of the holder main body 6A.

The left and right upper arms 6B are arranged to be laterally spaced from each other. The tip end portions of the left and right upper arms 6B are coupled to each other by an upper reinforcement beam 6E that extends laterally. The upper reinforcement beam 6E improves the stiffness of the left and right upper arms 6B. Each of the upper arms 6B is formed with an upper support hole 21 penetrating it in the lateral direction. The upper support holes 21 are arranged coaxially.

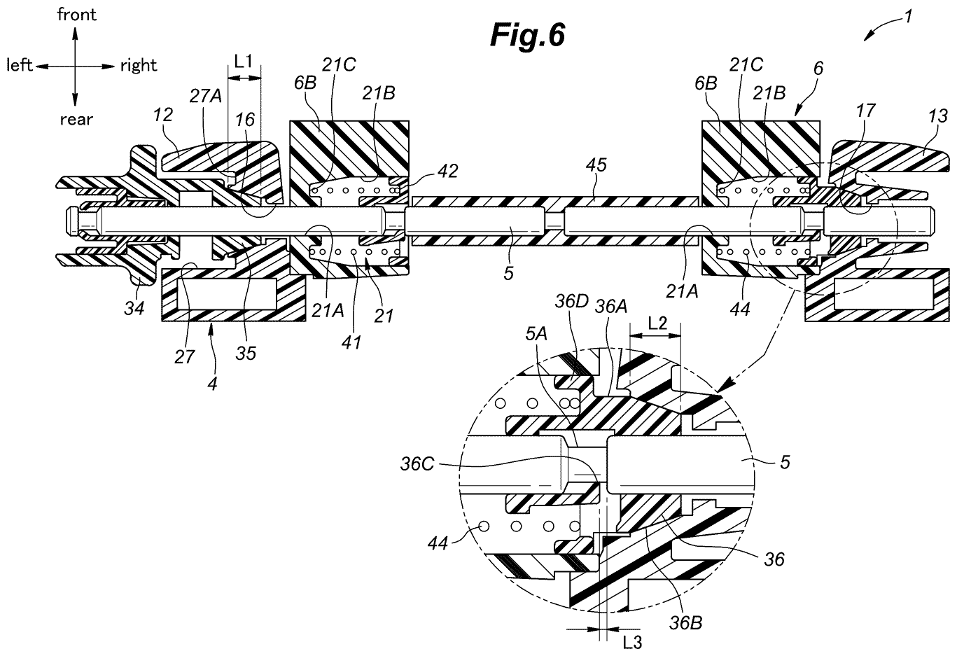

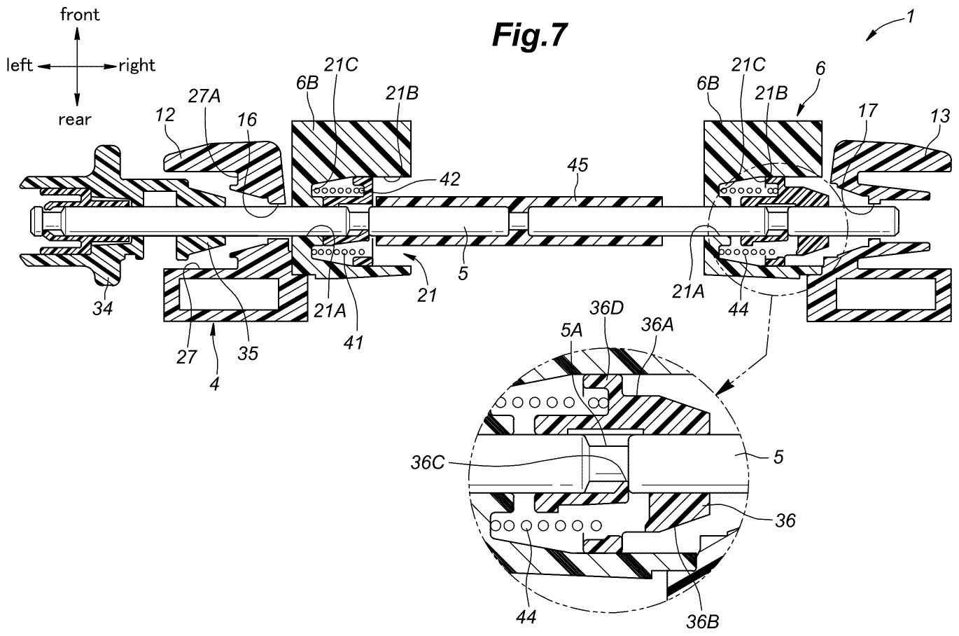

As shown in FIGS. 6 and 7, Each upper support hole 21 includes a small diameter part 21A positioned on the left, a large diameter part 21B positioned on the right, and a shoulder surface 21C defined between the small diameter part 21A and the large diameter part 21B and facing rightward. The small diameter part 21A opens in the left side surface of the upper arm 6B, and the large diameter part 21B opens in the right side surface of the upper arm 6B. The diameter of the large diameter part 21B is set to be larger than the diameter of the small diameter part 21A. The small diameter part 21A and the large diameter part 21B are arranged to be coaxial with each other.

The left and right upper arms 6B are disposed between the left guide part 12 and the right guide part 13. The shaft 5 is inserted in each of the upper support holes 21. Thereby, the holder 6 is pivotably supported by the shaft 5. The outer circumferential surface of the shaft 5 slidably contacts the inner circumferential surface of each of the left and right small diameter parts 21A. A gap is formed between the outer circumferential surface of the shaft 5 and the inner circumferential surface of each of the left and right large diameter parts 21B.

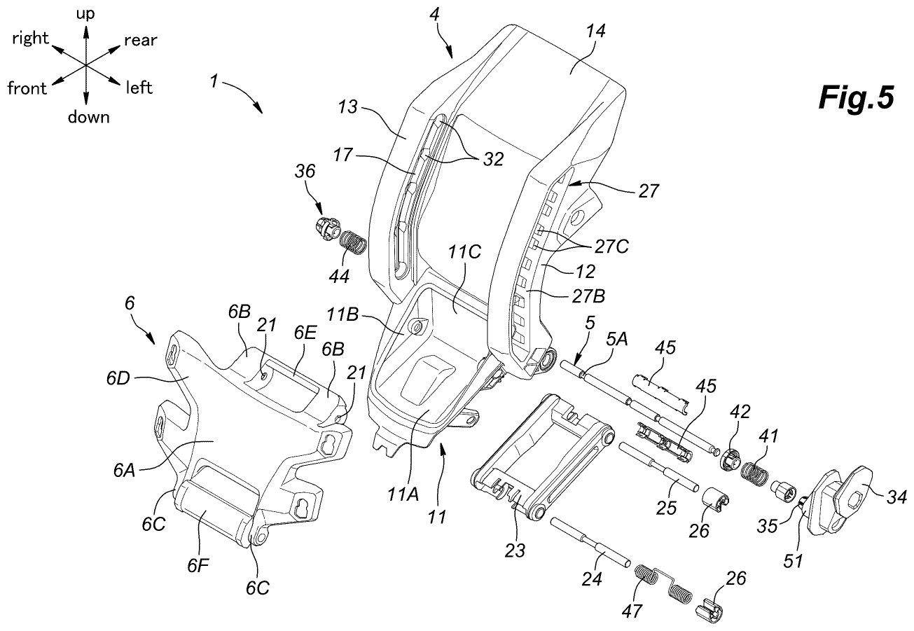

As shown in FIG. 5, the left and right lower arms 6C are arranged to be laterally spaced from each other. The tip end portions of the left and right lower arms 6C are coupled to each other by a lower reinforcement beam 6F that extends laterally. The lower reinforcement beam 6F improves the stiffness of the left and right lower arms 6C.

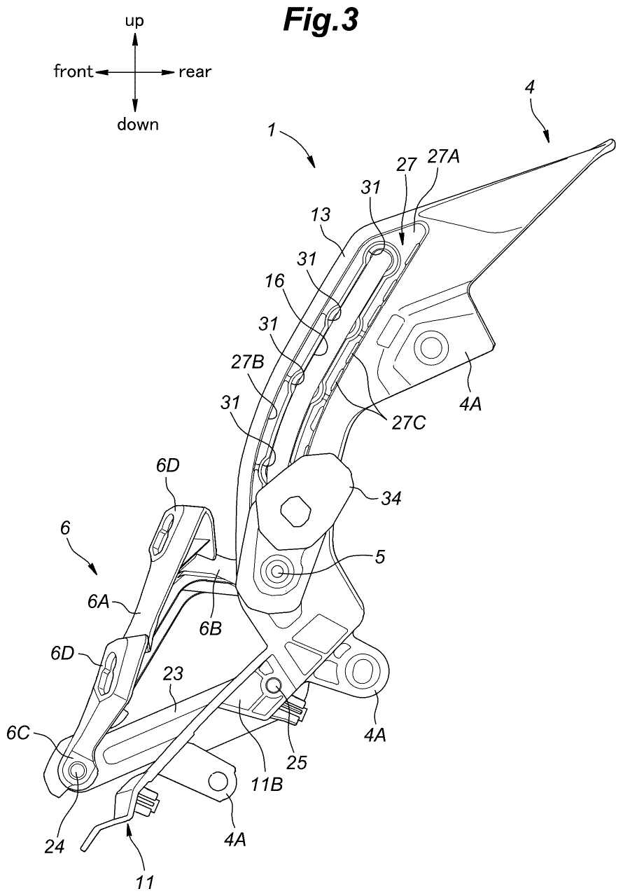

As shown in FIGS. 3 to 5, the left and right lower arms 6C are connected to the bracket lower portion 11 via a link 23. The link 23 is formed in a quadrilateral frame shape. A first support shaft 24 extending laterally is disposed to span between the left and right lower arms 6C. A second support shaft 25 extending laterally is disposed to span between the left and right side wall portions 11B of the bracket lower portion 11. One end of the link 23 is supported by the first support shaft 24. Thereby, the link 23 is connected to the holder 6 to be pivotable about the first support shaft 24. The other end of the link 23 is supported by the second support shaft 25. Thereby, the link 23 is connected to the bracket lower portion 11 to be pivotable about the second support shaft 25.

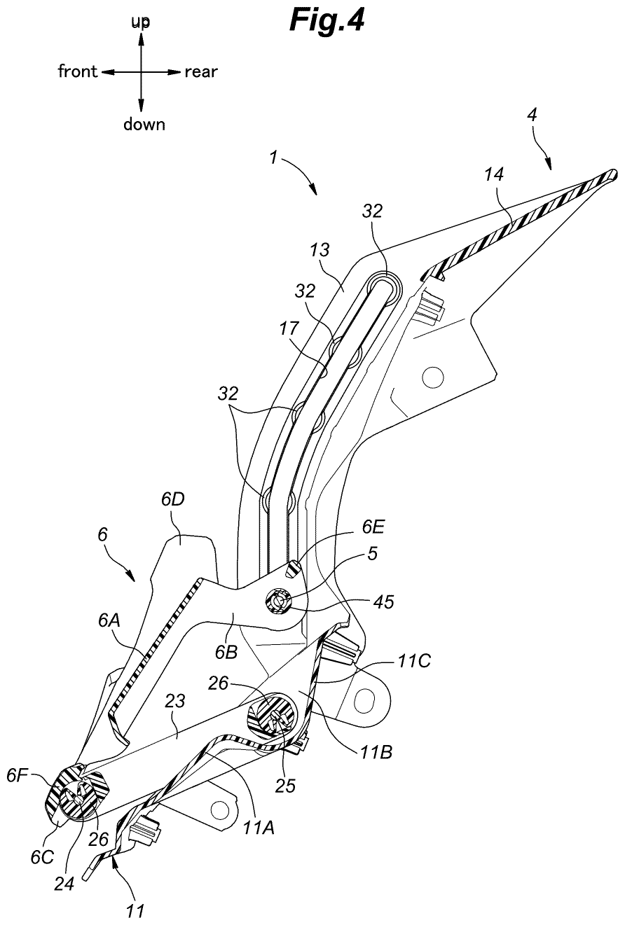

As shown in FIG. 4, each of the first support shaft 24 and the second support shaft 25 has a C ring 26 joined thereto. The C rings 26 are respectively joined to the first support shaft 24 and the second support shaft 25 to be unmovable in the lateral direction, and are fitted in recesses formed in the link 23. The C rings 26 prevent detachment of the first support shaft 24 and the second support shaft 25 from the link 23 in the lateral direction.

As shown in FIGS. 2 and 3, the left side surface of the left guide part 12 is formed with a groove 27 that is recessed rightward and extends along the left guide hole 16. The groove 27 configures a left part of the left guide hole 16. The groove 27 is formed to have a width larger than the width of the left guide hole 16. The groove 27 has a bottom surface 27A that faces leftward.

As shown in FIGS. 3 and 6, the left guide hole 16 is provided with multiple left lock holes 31 (first lock holes). In the present embodiment, the multiple left lock holes 31 are provided at intervals in the extension direction of the left guide hole 16. Each left lock hole 31 extends rightward from the bottom surface 27A of the groove 27. Each left lock hole 31 is a conical hole with a diameter decreasing toward the right. Each left lock hole 31 may be a through hole or a bottomed hole (recess). As seen in the lateral direction, each left lock hole 31 is disposed to overlap with the left guide hole 16. Each left lock hole 31 is formed such that the diameter thereof at the left end is larger than the width of the left guide hole 16.

As shown in FIGS. 4 and 6, the right guide hole 17 is provided with multiple right lock holes 32 (second lock holes). In the present embodiment, the multiple right lock holes 32 are provided at intervals in the extension direction of the right guide hole 17. Each right lock hole 32 extends rightward from the left side surface of the right guide part 13. Each right lock hole 32 is a conical hole with a diameter decreasing toward the right. Each right lock hole 32 may be a through hole or a bottomed hole (recess). As seen in the lateral direction, each right lock hole 32 is disposed to overlap with the right guide hole 17. Each right lock hole 32 is formed such that the diameter thereof at the left end is larger than the width of the right guide hole 17. The right lock holes 32 are provided at positions laterally corresponding to the left lock holes.

As shown in FIGS. 5 and 6, an operation part 34 for the user to grasp is provided at the left end portion of the shaft 5. Also, the shaft 5 is provided with a left fitting part 35 (first fitting part) that can be selectively fitted in one of the left lock holes 31 and a right fitting part 36 (second fitting part) that can be selectively fitted in one of the right lock holes 32.

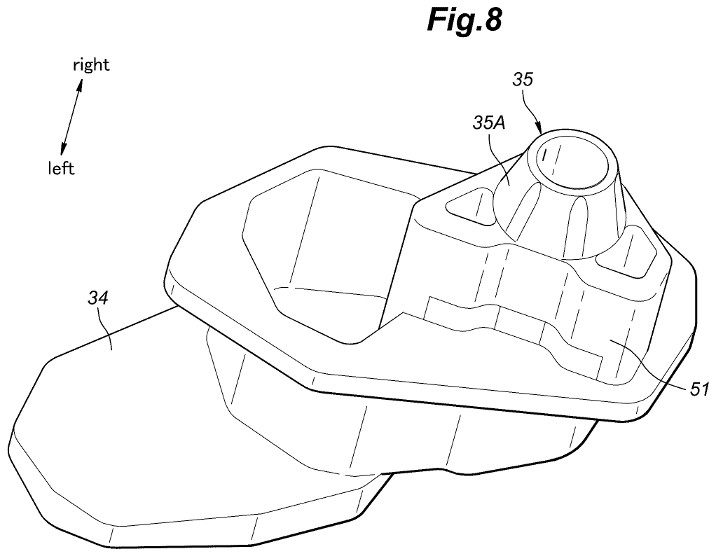

The left fitting part 35 is fixed to the shaft 5. Namely, the left fitting part 35 is joined to the shaft 5 to be unable to rotate and to be unable to be displaced in the axial direction of the shaft 5. The left fitting part 35 is disposed to the right of the operation part 34 and inside the left guide part 12. As shown in FIG. 8, in the present embodiment, the left fitting part 35 and the operation part 34 are formed integrally. The left fitting part 35 is a tubular body having a conical surface 35A on the outer circumference. The shaft 5 is inserted in the central part of the left fitting part 35. Preferably, the shaft 5 is press-fitted in the central part of the left fitting part 35. The conical surface 35A of the left fitting part 35 is provided at the right end of the left fitting part 35 and has a radius decreasing in the rightward direction.

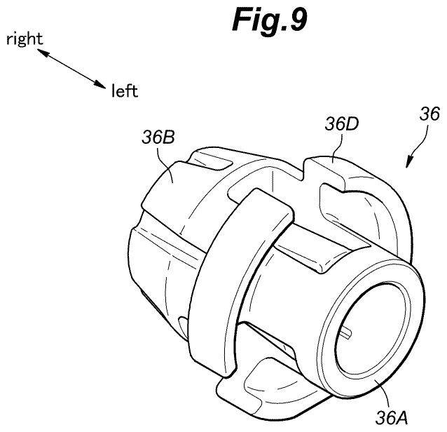

As shown in FIGS. 6 and 7, the right fitting part 36 is supported on the shaft 5 to be movable in the axial direction of the shaft 5 within a predetermined range. The right fitting part 36 is disposed inside the large diameter part 21B of the right upper arm 6B. As shown in FIG. 9, the right fitting part 36 has a tubular portion 36A and a conical surface 36B formed on the outer circumference of the right end of the tubular portion 36A. The shaft 5 is slidably inserted in the central part of the right fitting part 36. The conical surface 36B of the right fitting part 36 has a radius decreasing toward the right. As shown in FIGS. 6 and 7, the tubular portion 36A is provided with a locking claw 36C protruding toward the inside. The outer circumferential surface of the shaft 5 is formed with an annular locking groove 5A that extends in the circumferential direction. The locking claw 36C protrudes into the locking groove 5A. The locking claw 36C is movable in the lateral direction between the left end wall and the right end wall of the locking groove 5A. Namely, by the locking claw 36C contacting the left end wall or the right end wall of the locking groove 5A, the lateral movement of the right fitting part 36 relative to the shaft 5 is restricted within a predetermined range. The outer circumference of the tubular portion 36A is provided with a flange part 36D that protrudes outward.

As shown in FIG. 6, the shaft 5 is urged rightward by a first urging member 41. A retainer 42 is fixed to the shaft 5. Preferably, the first urging member 41 is a compression coil spring. The first urging member 41 is disposed in the large diameter part 21B of the left upper support hole 21. Preferably, the first urging member 41 is supported on the outer circumference of the shaft 5. The left end of the first urging member 41 is in contact with the shoulder surface 21C of the left upper support hole 21, and the right end of the first urging member 41 is in contact with the retainer 42.

The right fitting part 36 is urged rightward by a second urging member 44. Preferably, the second urging member 44 is a compression coil spring. The second urging member 44 is disposed in the large diameter part 21B of the right upper support hole 21. Preferably, the second urging member 44 is supported on the outer circumference of the shaft 5. The left end of the second urging member 44 is in contact with the shoulder surface 21C of the right upper support hole 21, and the right end of the second urging member 44 is in contact with the flange part 36D of the right fitting part 36.

In a case where the shaft 5 passes one of the left lock holes 31, the left fitting part 35 can be fitted in the left lock hole 31, and the right fitting part 36 can be fitted in the right lock hole 32. By moving the shaft 5 in a lock direction, which is rightward in the present embodiment, the left fitting part 35 is fitted in the left lock hole 31 and the right fitting part 36 is fitted in the right lock hole 32. Thereby, the shaft 5 becomes unmovable relative to the left guide hole 16 and the right guide hole 17. This state is referred to as a lock state of the windshield device 1.

As shown in FIG. 7, by moving the shaft 5 in a release direction, which is opposite from the lock direction and is leftward in the present embodiment, the left fitting part 35 is released from the left lock hole 31 and the right fitting part 36 is released from the right lock hole 32. Thereby, the shaft 5 becomes movable relative to the left guide hole 16 and the right guide hole 17. Namely, the shaft 5 can move up and down along the left guide hole 16 and the right guide hole 17. This state is referred to as a release state of the windshield device 1.

Since the first urging member 41 urges the shaft 5 relative to the bracket 4 in the lock direction, the left fitting part 35 is maintained in the state fitted in the left lock hole 31 in the lock state of the windshield device 1. Also, since the second urging member 44 urges the right fitting part 36 relative to the bracket 4 in the lock direction, the right fitting part 36 is maintained in the state fitted in the right lock hole 32 in the lock state of the windshield device 1.

As shown in FIGS. 2, 4, and 6, a cover 45 is attached to the central part of the shaft 5 in the longitudinal direction. The cover 45 is disposed between the left and right upper arms 6B. The cover 45 is made of resin material. The cover 45 covers the outer circumferential surface of the shaft 5 between the left and right upper arms 6B and suppresses reflection of light from the outer circumferential surface of the shaft 5. The cover 45 is formed by combining two members into a tubular shape. With a convex part provided on the inner circumferential surface of the cover 45 being locked by a concave part formed on the outer circumferential surface of the shaft 5, movement of the cover 45 relative to the shaft 5 is restricted.

As shown in FIG. 5, a third urging member 47 for urging the link 23 relative to the holder 6 is provided between the holder 6 and the link 23. Preferably, the third urging member 47 is a torsion coil spring and is supported on the first support shaft 24. The third urging member 47 urges the link 23 relative to the holder 6 in one of the rotational directions about the first support shaft 24 and suppress rattling between the bracket 4 and the link 23 and rattling between the holder 6 and the link 23. Preferably, the third urging member 47 urges the link 23 relative to the holder 6 in a direction to lift the holder 6. Thereby, it is possible to prevent the holder 6 and the screen from descending due to their own weight in the release state of the windshield device 1.

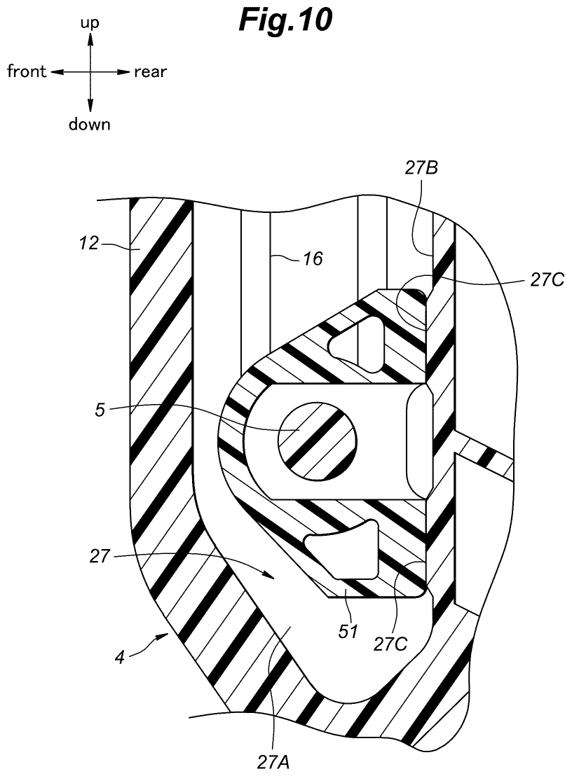

As shown in FIGS. 8 and 10, an intermediate part 51 is provided between the operation part 34 and the left fitting part 35. The intermediate part 51 is a tubular body protruding rightward from the operation part 34 and is disposed around the shaft 5. The left fitting part 35 protrudes rightward from the right end of the intermediate part 51. When the left fitting part 35 is fitted in the left lock hole 31, the intermediate part 51 protrudes into the groove 27 of the left guide hole 16. A side wall 27B of the groove 27 is formed with multiple convex parts 27C. When the left fitting part 35 is fitted in the left lock hole 31, the intermediate part 51 contacts at least two of the convex parts 27C, whereby rotation of the intermediate part 51 and the operation part 34 about the axis of the shaft 5 is restricted.

As shown in FIG. 3, the bracket 4 includes multiple fastening parts 4A. The multiple fastening parts 4A are fastened to the vehicle body 3 by fasteners such as bolts and nuts. Preferably, the fastening parts 4A are provided on the lower surface of the lower wall portion 11A, the lower end and the upper end of the left guide part 12, and the lower end and the upper end of the right guide part 13, for example.

The operation and effects of the windshield device 1 according to the foregoing embodiment will be described in the following. When the left fitting part 35 is fitted in one of the multiple left lock holes 31 and the right fitting part 36 is fitted in the corresponding right lock hole 32, the position of the shaft 5 is fixed. Accordingly, the position of the rear end of the holder 6 pivotably supported by the shaft 5 is fixed. At this time, with pivoting of the link 23, the position of the front end of the holder 6 is determined according to the position of the rear end of the holder 6. Due to the first urging member 41 that urges the shaft 5 rightward, the left fitting part 35 is maintained in the state fitted in the left lock hole 31, and due to the second urging member 44 that urges the shaft 5 rightward, the right fitting part 36 is maintained in the state fitted in the right lock hole 32. Thereby, the positions of the holder 6 and the screen 7 are maintained.

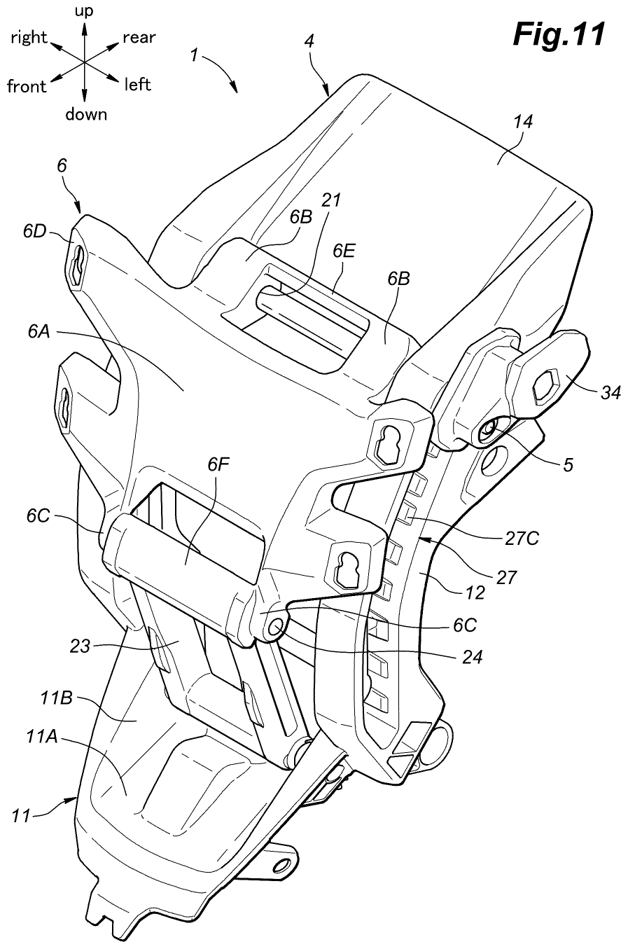

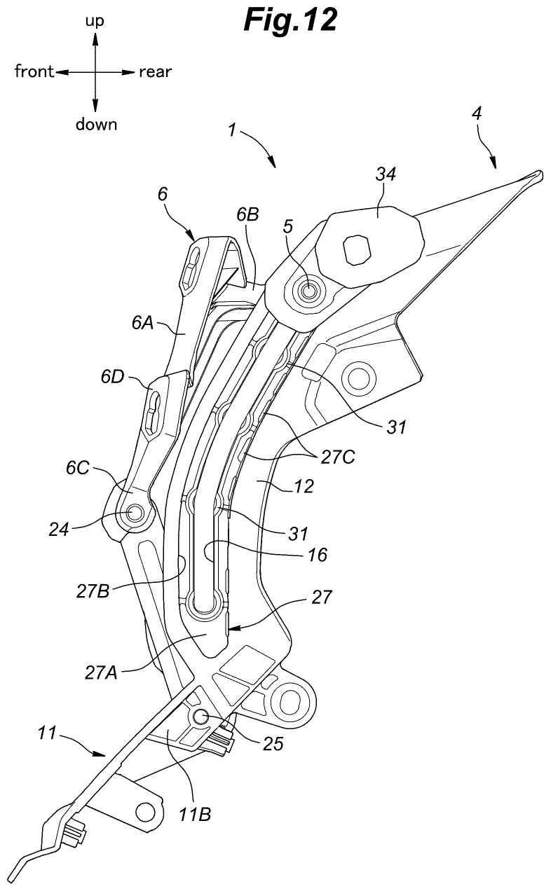

By pulling the operation part 34 leftward, the user can change the position and angle of the screen 7. Since the operation part 34 is provided at the left end of the shaft 5, the user riding the motorcycle can operate the operation part 34 with only the left hand without taking the right hand off the accelerator. When the user pulls the operation part 34 leftward against the urging forces of the first urging member 41 and the second urging member 44, the left fitting part 35 is released from the left lock hole 31 and the right fitting part 36 is released from the right lock hole 32. Accordingly, the windshield device 1 is brought into the release state, in which the shaft 5 can move relative to the left guide hole 16 and the right guide hole 17. As shown in FIGS. 11 and 12, the user may move the shaft 5 along the left guide hole 16 to place the shaft 5 in another left lock hole 31. At this time, the link 23 pivots according to the position of the shaft 5, whereby the position and angle of the holder 6 are determined. When the user weakens the force pulling the operation part 34 leftward, the left fitting part 35 is fitted in the left lock hole 31 that opposes thereto and the right fitting part 36 is fitted in the corresponding right lock hole 32 due to the urging forces of the first urging member 41 and the second urging member 44.

Since the right fitting part 36 is supported to be movable in the axial direction of the shaft 5 within the predetermined range, even if a manufacturing error or deformation occurs in the windshield device 1, the right fitting part 36 can move relative to the shaft 5, so that the left fitting part 35 can be fitted in the left lock hole 31 and the right fitting part 36 can be fitted in the right lock hole 32. Thus, the windshield device 1 capable of stably keeping the position of the screen 7 can be provided. Also, since the left fitting part 35 is reliably fitted in the left lock hole 31 and the right fitting part 36 is reliably fitted in the right lock hole 32, rattling of the holder 6 and the screen 7 can be suppressed.

Due to the first urging member 41 that urges the shaft 5 rightward relative to the bracket 4, the left fitting part 35 fixed to the shaft 5 can be reliably fitted in the left lock hole 31. Due to the second urging member 44 that urges the left fitting part 35 rightward relative to the bracket 4, the right fitting part 36 can be reliably fitted in the right lock hole 32.

Each of the left fitting part 35 and the right fitting part 36 is a conical tubular body, and each of the left lock hole 31 and the right lock hole 32 is a conical through hole. Therefore, the left fitting part 35 is allowed to be smoothly fitted in the left lock hole 31, and the right fitting part 36 is allowed to be smoothly fitted in the right lock hole 32.

In the state in which the left fitting part 35 is fitted in the left lock hole 31 and the right fitting part 36 is fitted in the right lock hole 32, a fitting margin L1 of the left fitting part 35 with respect to the left lock hole 31 is set to be greater than a total of a fitting margin L2 of the right fitting part 36 with respect to the right lock hole 32 and a play length L3 between the right fitting part 36 and the shaft 5 in the release direction (L1>L2+L3). The fitting margin L1 of the left fitting part 35 with respect to the left lock hole 31 is a protrusion length of the left fitting part 35 into the left lock hole 31 in the lateral direction. The fitting margin L2 of the right fitting part 36 with respect to the right lock hole 32 is a protrusion length of the right fitting part 36 into the right lock hole 32 in the lateral direction. In the state in which the right fitting part 36 is fitted in the right lock hole 32, the locking claw 36C of the right fitting part 36 is located in a laterally middle part of the locking groove 5A. Therefore, when the shaft 5 is moved in the release direction from the lock state, the right fitting part 36 is maintained in the state fitted in the right lock hole 32 until the right end of the locking groove 5A comes into contact with the locking claw 36C. In the state in which the right fitting part 36 is fitted in the right lock hole 32, the distance between the locking claw 36C of the right fitting part 36 and the right end of the locking groove 5A is the play length L3.

When the shaft 5 is moved leftward from the lock state, the right fitting part 36 does not move relative to the right lock hole 32 until the shaft 5 is moved leftward by the play length L3. When the movement amount of the shaft 5 exceeds the play length L3, the right end of the locking groove 5A pushes the locking claw 36C of the right fitting part 36 leftward, and the right fitting part 36 moves leftward relative to the right lock hole 32. When the movement amount of the shaft 5 exceeds L2+L3, the right end of the right fitting part 36 is positioned leftward of the left end of the right lock hole 32. Namely, the right fitting part 36 gets out of the right lock hole 32. At this time, the right end of the left fitting part 35 is still positioned inside the left lock hole 31. When the movement amount of the shaft 5 exceeds L1, the right end of the left fitting part 35 is positioned leftward of the left end of the left lock hole 31. Namely, the left fitting part 35 gets out of the left lock hole 31. According to this aspect, when the left fitting part 35 is released from the left lock hole 31, it is ensured that the right fitting part 36 which is movable relative to the shaft 5 can be released from the right lock hole 32.

Concrete embodiments have been described in the foregoing, but the present invention can be modified in various ways without being limited to the above embodiments. For example, the windshield device 1 may be used in other types of the motorcycle 2, such as a scooter type motorcycle with a low floor but no straddling part or a three-wheel type, or may be used in other saddle-ride type vehicles, such as a snowmobile or a personal watercraft. Also, the windshield device 1 may be used in various vehicles other than the saddle-ride type vehicles, such as an automobile, a kickboard, etc. Also, the all configurations of the windshield device 1 may be left-right reversed. Namely, the windshield device 1 may be configured such that the operation part 34 is provided at the right end of the shaft 5. the release direction is rightward, and the lock direction is leftward.

1. A windshield device, comprising:
a fixing member configured to be fixed to a vehicle body and having a first guide hole and a second guide hole that are laterally spaced from each other;
a shaft extending laterally and movably inserted in the first guide hole and the second guide hole;
a holding member supported on the shaft; and
a screen supported by the holding member,
wherein the first guide hole is provided with multiple first lock holes,
the second guide hole is provided with multiple second lock holes at positions laterally corresponding to the first lock holes, and
a first fitting part that can be selectively fitted in one of the first lock holes is fixed to the shaft, and a second fitting part that can be selectively fitted in one of the second lock holes is supported on the shaft to be movable in an axial direction of the shaft within a predetermined range.

2. The windshield device according to claim 1, wherein in a state in which the first fitting part is fitted in one of the first lock holes and the second fitting part is fitted in one of the second lock holes corresponding to the one of the first lock holes, a fitting margin of the first fitting part with respect to the one of the first lock holes is set to be greater than a total of a fitting margin of the second fitting part with respect to the one of the second lock holes and a play length between the second fitting part and the shaft in a release direction.
